(19) United States
(12) Patent Application Publication
(10) Pub. No.: US 2004/0161144 A1
(43) Pub. Date: Aug. 19, 2004

(54) Method for producing an image

(76) Inventor: Karl Barth, Hoechstadt (DE)

Correspondence Address: SCHIFF HARDIN, LLP, PATENT DEPARTMENT, 6600 SEARS TOWER, CHICAGO, IL, 60606-6473, US

(21) Appl. No.: 10/721,936

(22) Filed: Nov. 25, 2003

(30) Foreign Application Priority Data
Nov. 25, 2002 (DE) 10254908.7

(51) Int. Cl. G06K 9/00

(52) U.S. Cl. 382/154; 382/131

(57) ABSTRACT

In a method for producing an image, the surface of a three-dimensional image of a subject is segmented, and the three-dimensional image is stored with a volume dataset. The volume dataset is then transformed such that the segmented surface is transformed into a plane. Lastly, the transformed surface of the three-dimensional image is represented with a slice of predetermined thickness inside and/or outside the three-dimensional image

### BACKGROUND OF THE INVENTION

1. Field of the Invention

The present invention relates to a method for producing an image from a three-dimensional image of a subject.

2. Description of the Prior Art

Images that are picked up with modern imaging medical devices have a relatively high resolution in all directions, and therefore amplified 3D projections (volume datasets) are generated with them. Imaging medical devices include ultrasound devices, computed tomography devices, magnetic resonance devices or X-ray devices or PET scanners, for example. Computed tomography or X-ray devices can also frequently be utilized, because the radiation load to which a living being is exposed during an examination with one of these devices has decreased. Volume datasets contain a larger amount of data than image datasets of conventional two-dimensional images, which is why an evaluation of volume datasets is relatively time-consuming. The actual pick-up of the volume datasets currently takes approximately half a minute, but it frequently takes half an hour or more to search through and edit the volume dataset. Methods for automatic recognition and editing are needed and desirable.

Furthermore, it may occur that fine structures are submerged, particularly in the representation of large volume datasets, i.e. contrast agents may be needed in order to make such fine structures visible. This is true of the representation of small vessels.

Until the year 2000, it was customary practice in computed tomography (CT) to reach a diagnosis based almost exclusively on axial slice stacks (slice images) or at least to focus findings predominantly on the slice images. Since 1995, due to the power of computers, 3D representations on diagnostic consoles have been widespread; initially they had a scientific or ancillary importance. Essentially four basic methods of 3D visualization were developed in order to facilitate diagnosis by a physician:

1. Multiplanar reformatting (MPR): This is no more than a reconfiguration of the volume dataset in a different orientation from the original horizontal slices. It basically breaks down into orthogonal MPR (three MPRs, respectively perpendicular to a coordinate axis), free MPR (oblique slices; derivative=interpolated) and curved MPR (slice representation parallel to an arbitrary path through the image of the body of the living being and e.g. perpendicular to the MPR in which the path was drawn).

2. Shaded Surface Display (SSD): segmenting the volume dataset and representing the surface of the subject that is being cut, usually strongly influenced by orienting at the CT values and manual help editing.

3. Maximal Intensity Projection (MIP): representation of the highest intensity along each ray. In what is known as thin MIP, only a sub-volume is represented.

4. Volume rendering (VR): encompasses modeling of the attenuation of the ray that penetrates the subject in a similar manner as an X-ray. The entire depth of the imaged body (partly translucent) is captured; however, details of small and above all thin-sliced subjects are lost. The representation is influenced manually by the setting of what are known as transfer functions (color lookup tables).

Another important technique for rapid visualization, which is not actually a 3D method, is film-type immersion in a slice stack in which one slice after the other is represented.

U.S. Pat. No. 4,879,652 describes a method for a special shaded representation of a subject that is imaged in a volume dataset. The volume dataset is produced with a nuclear medical device.

U.S. Application Publication 2002/0164061 and U.S. Pat. No. 5,425,407 describe methods for recognizing contours that are imaged in a medical image.

### SUMMARY OF THE INVENTION

An object of the present invention is to provide a method that produces an image allowing the representation of the image that is stored in the volume dataset to be improved.

This object is achieved in accordance with the invention by a method for producing an image including the steps of in a computer segmenting the curved surface of a three-dimensional image of a subject, storing the three-dimensional image is stored with a volume dataset, transforming the volume dataset so that the segmented curved surface is transformed into a plane, and representing the curved surface of the three-dimensional image subsequent to its transformation into a plane with a slice of predetermined thickness inside and/or outside the three-dimensional image.

With the inventive method, an intensive search through the complete volume dataset for specific queries can be automated and thus simplified and accelerated for the physician. With the inventive method, a type of “curved MIP” is created; i.e., a complex reformatting of the image contents of the volume dataset is performed. This occurs parallel to the segmented surface of the three-dimensional image rather than perpendicular to a plane and parallel to a line like in curved MPR.

First, the surface of the three-dimensional image is automatically determined (segmented out). This typically curved surface is then transformed into the plane as if the three-dimensional image were to be unrolled. The projection of the surface of the earth on maps is an analogy. Particularly when the subject is the torso of a living being which has a quasi-columnar shape with an approximately elliptical base, the surface can be unrolled into a flat area.

If the three-dimensional image takes the form of consecutive computed tomography slice images, and the image data of each slice image are described in Cartesian coordinates (e.g. representation of tissue or structures near the skin along a hollow bone), as in a preferred embodiment of the invention, then the segmenting of the surface of the three-dimensional image can be as follows.

A coordinate transformation is performed for each slice image to polar coordinates relative to a line that extends through the three-dimensional image and is oriented at least substantially at a right angle to the individual slice images. The contours that are imaged in each transformed slice image are determined and allocated to the surface of the three-dimensional image. The pixels of the contours that have been determined are transformed back into the coordinate system that is allocated to the volume dataset. Pixels are -re-extracted along the contours for the representation of the surface, after its transformation into the plane, of the three-dimensional image with the slice of predetermined thickness inside and/or outside the three-dimensional image.

The rolled flat representation of the surface of the three-dimensional image comprises a slice of predetermined thickness below and/or above the surface. The thickness equals several millimeters when blood vessels are being examined, for example. In the examination of the structure of hollow bones, the thickness may equal almost a centimeter, and in an examination of the meninges, the slice is again relatively thin. In this hemispherical configuration, there is a close resemblance to cartographic projection, or a strip shaped reorganization is possible in the sense of the article “Volume Rendering” (R. Drebin, Computer Graphics 22 (4), August 1988: 65-74).

For the slice of predetermined thickness of the generated image plane, depending on the problem, a reasonable computation technique is applied for the pixels arranged one behind the other, depending on the requirements of the representation. Margin conditions are a variable or constant spacing of the structure of the surface being searched for, noise that may have to be suppressed, the characteristic that a structure has a higher density than the environment (vessels (filled with contrast agent), calcifications), or some other feature (higher-order statistics). Because only the image of the surface and the imaged slice of predetermined thickness are represented, contrast is gained.

According to a preferred variant of the invention, the three-dimensional image is an image of at least part of a living being, and the segmented surface is the image of the body surface of the imaged living being.

The image of the body surface of the living being or images of slices near the skin to defined depths can be automatically represented. Possible applications include preparation for plastic surgeries, preparation for vascular surgery, melanoma screening, and many more applications. For instance, it is possible to render high-resolution representations of the subcutaneous vascular tree.

The inventive method is not limited to the body surface (skin); rather, a further embodiment of the invention provides that the subject is a bone or organ of a living being. Thus, the surface of a deeper organ or a boundary surface within an organ can be examined. Bone examinations (condition of trabecula) for evaluating the growth or decay (in osteoporosis) are also possible applications.

In order to obtain different views of the transformed surface, embodiments of the invention provide that the transformed plane is oriented in the line of sight into the three-dimensional image and/or the line of sight away from the three-dimensional image. The surface being examined, that is to say, its image, can thus be examined from different lines of view.

For different representations of the slice of predetermined thickness, the image data that are allocated to the slice of predetermined thickness can be represented by means of MPR (multiplanar reformation), MIP (maximal or minimal intensity projection), volume rendering (VR) and/or filtering (smoothing, edge accentuation or otherwise structure accentuation).

### DESCRIPTION OF THE DRAWINGS

FIG. 1 is a computed tomography apparatus operable in accordance with the invention.

FIG. 2 is a three-dimensional image of the ventral area of a patient in the form of a volume dataset consisting of several slice images.

FIG. 3 is a slice image of the volume dataset represented in FIG. 2.

FIG. 4 shows image information, after transformation to polar coordinates, of the slice image represented in FIG. 3.

FIG. 5 is an image dataset representing the image of the body surface after transformation into a plane and an image of a slice adjacent the body surface.

FIG. 6 is the image that is allocated to the image dataset shown in FIG. 5.

### DESCRIPTION OF THE PREFERRED EMBODIMENTS

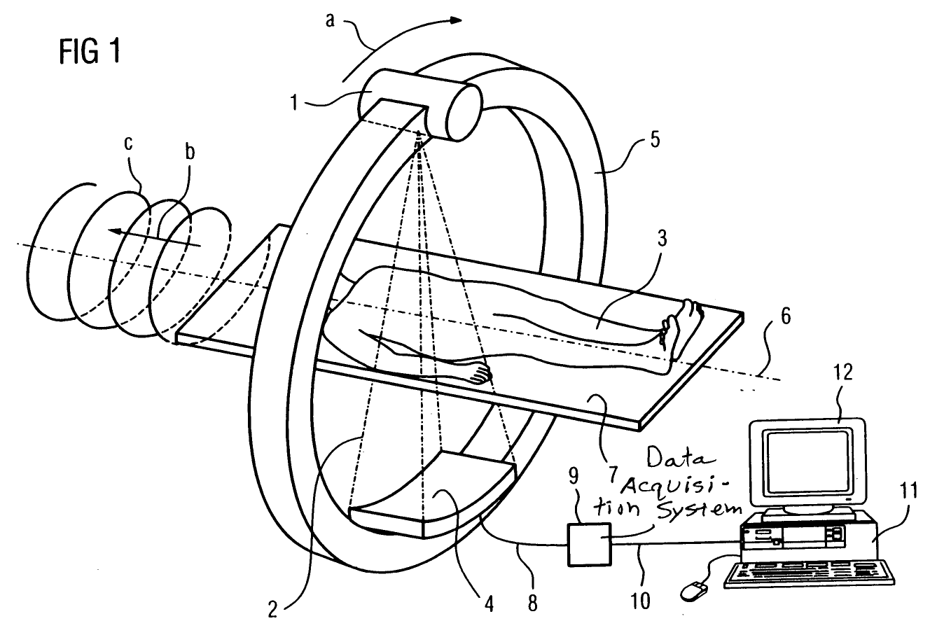

FIG. 1 is a schematic representation of a computed tomography apparatus with an X-ray source 1 which emits a pyramidal X-ray beam 2 the peripheral rays of which are represented as dotted lines in FIG. 1, which passes through an examination subject, for instance a patient 3, and strikes a radiation detector 4. This X-ray source 1 and the X-ray detector 4 are disposed facing one another on opposite sides of an annular gantry 5. The gantry 5 is supported by a bearing device that is not shown in FIG. 1, such that it pivots relative to a system axis 6 that extends through the midpoint of the annular gantry 5 (arrow a).

In the exemplary embodiment, the patient 3 lies on a table 7 that is transparent to X-ray, which is supported by means of a bearing device that is not shown in FIG. 1 in such a way that it can be displaced along the system axis 6 (arrow b).

The X-ray source 1 and X-ray detector 4 form a measuring system which is rotatable relative to the system axis 6 and displaceable along the system axis 6 relative to the patient 3, so that the patient can be irradiated at different projection angles and different positions relative to the system axis 6. From the generated output signals of the radiation detector 4, a data acquisition system 9 forms measurement values, which are fed to a computer 11, which computes, by methods known to those skilled in the art, an image of the patient 3 that can be reproduced on a monitor 12 that is connected to the computer 11. In the exemplary embodiment, the data acquisition system 9 is connected to the radiation detector 4 by an electrical line 8, which terminate in a wiper ring system, or a wireless transmission path, to obtain signals from the radiation detector 4, and is connected to the computer 11 by an electrical line 10.

The computed tomography apparatus shown in FIG. 1 can be utilized for sequential scanning and spiral scanning.

In sequential scanning, the patient 3 is scanned slice by slice. The X-ray source 1 and the X-ray detector 4 are rotated around the patient 3 relative to the system axis 6, and the measuring system, which includes the X-ray source 1 and the X-ray detector 4, captures a number of projections in order to scan a two-dimensional slice of the patient 3. From the measurement values so acquired, a slice image representing the scanned slice is reconstructed. Between the scanning of consecutive slices, the patient 3 is moved along the system axis 6. This process is repeated until all relevant slices are picked up.

During a spiral scan, the measuring system formed by the X-ray source 1 and the X-ray detector 4 rotates relative to the system axis 6, and the table 7 moves continuously in the direction of arrow b; that is, the measuring system comprising the X-ray source 1 and the X-ray detector 4 continuously moves on a spiral path c relative to the patient 3 until the region of interest of the patient 3 is completely covered. A volume dataset is thereby generated, which is coded according to the customary DICOM standard in the present embodiment.

In the exemplary embodiment, a volume dataset of the ventral area of the patient 3 consisting of several consecutive slice images is generated with the computed tomography apparatus represented in FIG. 1. The volume dataset that is represented schematically in FIG. 2 comprises approximately 250 CT slices (slice images) of the matrix 512×512. FIG. 2 shows seven slice images as an example, which are indicated by reference characters 21 to 27.

In the exemplary embodiment, the body surface that is imaged with the volume dataset and the imaged tissue and imaged vessels immediately beneath it are represented. To that end, in the exemplary embodiment, a suitable computer program runs on the computer 11, which executes the steps described below.

First, for determining the imaged body surface, each slice image 21 to 27 of the volume dataset is transformed to polar coordinates (r,Φ) relative to a line G through the three-dimensional image of the stomach region of the patient 3 in a first pass. The line G is oriented at least substantially perpendicular to the individual slice images 21 to 27. In the exemplary embodiment, the line G extends through the center of the volume dataset and corresponds to the z-axis of the coordinate system that defines the volume dataset.

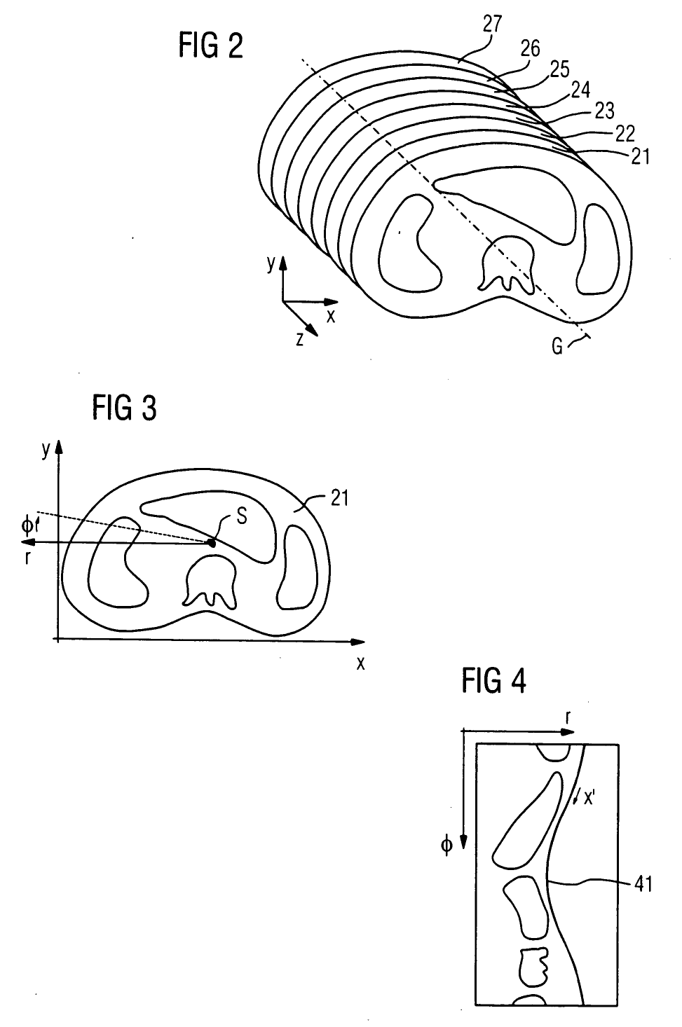

In the exemplary embodiment, each slice image 21 to 27, of which the slice image 21 is exemplarily represented in FIG. 3, is described with Cartesian coordinates (x,y). Next, the image information of each slice image 21 to 27 is rearranged radially, being transformed to polar coordinates (r,Φ) relative to the line G, i.e. relative to the respective point of intersection between the line G and the corresponding slice image. As an example, the point of intersection S between the line G and the slice image 21 is represented in FIG. 3. With the transformation to polar coordinates (r,Φ), the image of the body surface of the patient 3 is also transformed, being represented as a closed contour in each transformed axial slice (slice image). FIG. 4 represents an example of a contour 41 that is allocated to the image of the body surface of the patient 3 for the slice image 21 subsequent to its transformation to polar coordinates (r,Φ).

The result of the transformation to polar coordinates (r,Φ) is a linearly mapped radial brightness profile. In this rectangular matrix (derivative image matrix), a filtering is performed, which accentuates the contours that are allocated to the body surface, such as the contour 41 represented in FIG. 4. The filter responses replace the brightness values in the derivative image matrix. Next is the search for the optimal path in this image matrix from top to bottom at the identical start point/end point. In the exemplary embodiment, this occurs by means of dynamic optimization, such as described in Dynamic programming and stochastic control processes (R. Bellmann, Information and Control 1(3), September 1958: 228-39). The optimal path represents the radial vectors to the body surface pixels. In a further step, the contours 41 that have been transformed to polar coordinates are transformed back into the original coordinates of the volume dataset, so that the whole contour ensemble that is determined from the individual contours of the slice images 21 to 27 and the corresponding pixels of the original volume dataset are checked in relation to the individual contours across all slice images 21 to 27. This contributes particularly to the suppression of errors (outliers) and to reliability. At the probable points of error, re-segmenting is performed in the individual slice images 21 to 27, with subsequent checking of the 3D context. The image of the patient 3 in the volume dataset is thus segmented.

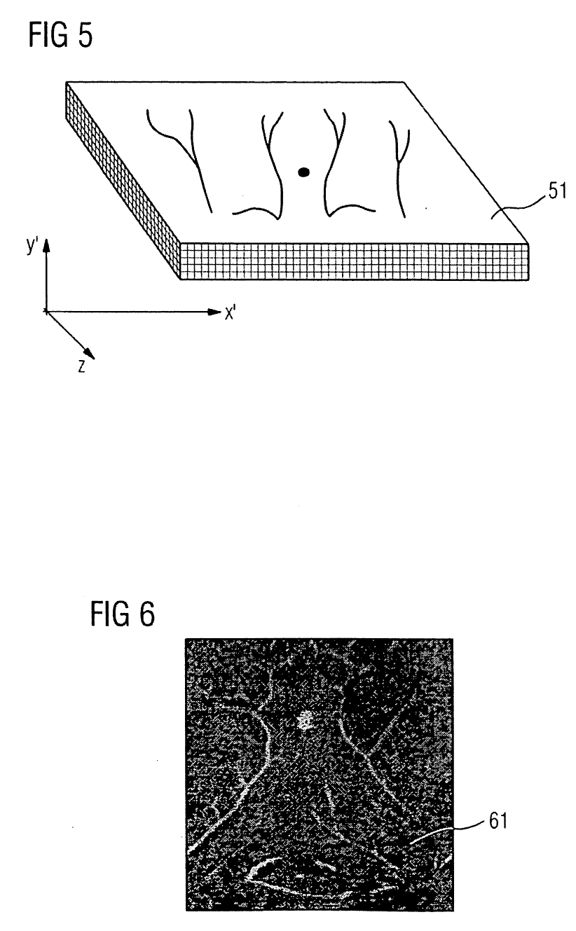

In the exemplary embodiment, this is followed by a re-extraction at a right angle to the image of the segmented body surface in the volume dataset. Whereas, in the transformation to polar coordinates (r,Φ), brightness profiles were computed from the original data at a right angle to all points of a circle (idealized surface contour) and mapped as a rectangular matrix, in the re-extraction, profiles are obtained at each pixel of the image of the segmented body surface (body surface contour) at a right angle to the surface gradient. This re-extraction is remapped as a rectangular matrix. A perpendicular line therein, for instance the centerline, corresponds to the pixels of the image of the body surface. For example, at left in FIG. 6 are the CT measurement values near the body surface on the inside. The volume dataset is thus transformed such that the segmented image of the body surface of the patient 3 is transformed into a plane. Thus, depending on the problem, a slice below and/or above the segmented surface that has been transformed into a plane—in the exemplary embodiment, the segmented and transformed image of the body surface of the patient 3—is calculated for measurement value determination (re-extraction). The thickness of this slice it entered into the computer 11 prior to segmentation in the case of the present exemplary embodiment. As a result, an image dataset 51 emerges as represented in FIG. 5, which has the structure of a thin voxel cuboid.

In the exemplary embodiment, the thickness of the slice adjacent the body surface is some 5 mm. It is thus possible that, in the exemplary embodiment, vessels situated just below the skin of the patient 3 in the groin area can be represented without contrast agent. Above this thickness of 5 mm, the highest density is computed perpendicular to the body surface, and a thin MIP is generated, but, with reference to the original volume data, along the curved image of the body surface. For an evaluation, the image dataset 51 that is represented in FIG. 5 can be utilized, the corresponding image 61 of which is represented in FIG. 6 and displayed on monitor 12.

The minimum can be utilized instead of the maximum signal value, or some other calculation can be performed for other problems. For relatively thick structures, for example, an improvement of the signal/noise ratio can be achieved with the aid of an average formation or some other smoothing operator. With the selection of a narrow band of signal values (e.g. Hounsfield units), it is possible to select structures with particular characteristics (e.g. blood vessels, calcifications etc.) or to fade such structures out in complementary fashion.

With analysis in the plane parallel to the orientation surface (FIG. 5), the measurement values can be analyzed and visually displayed in the context of their surface (e.g. texture characteristics).

In the exemplary embodiment, the volume dataset is produced with a computed tomography apparatus. For the inventive method and the inventive medical device, the volume dataset can also be produced with some other imaging device, such as a magnetic resonance device, X-ray device, ultrasound device, or PET scanner. The volume dataset need not take the form of several consecutive computed tomography slice images.

The image that is to be segmented need not be the body surface of a living being. In particular, the inventive method is suited for images of surfaces of organs or bones as well.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for producing an image, comprising the steps of:
in a computer, segmenting a curved surface of a three-dimensional image of a subject, and storing the three-dimensional image in a memory accessible by the computer as a volume dataset;
transforming the volume dataset to transform the segmented curved surface into a plane; and
representing the transformed curved surface of the three-dimensional image with a slice of a predetermined thickness at at least one location selected from the group consisting of inside of the three-dimensional image and outside of the three-dimensional image.

2. A method as claimed in claim 1 wherein said three-dimensional image comprises a plurality of consecutive computed tomography slice images, with image data for each slice image being described with Cartesian coordinates, and wherein the step of segmenting the curved surface of the three-dimensional image comprises:
performing a coordinate transformation for each slice image to polar coordinates relative to a line extending through the three-dimensional image that is oriented substantially perpendicularly to the slice images;
determining contours that are image in each transformed slice image and allocated to the surface of the three-dimensional image;
transforming the pixels of the contours back into the coordinate system of the volume dataset; and
re-extracting pixels along said contours for representing the surface of the three-dimensional image, after transformation of the image into the plane, with said slice of predetermined thickness.

3. A method as claimed in claim 1 comprising employing an image of at least a part of a living subject as said three-dimensional image, and wherein said surface is a body surface of the living being.

4. A method as claimed in claim 1 comprising selecting said subject from the group consisting of a bone of a living being and an organ of a living being.

5. A method as claimed in claim 1 comprising orienting said plane along a line of sight toward said three-dimensional image.

6. A method as claimed in claim 1 comprising orienting said plane along a line of sight away from said three-dimensional image.

7. A method as claimed in claim 1 comprising representing image data allocated to said slice of predetermined thickness by a technique selected from the group consisting of mulitplanar reformation, maximal intensity projection, minimal intensity projection, and volume rendering.

8. A method as claimed in claim 1 comprising the additional step of subjecting said image data to filtering for an image enhancement selected from the group consisting of smoothing, edge-accentuation and structure-accentuation.
